(19) United States
(12) Patent Application Publication
(10) Pub. No.: US 2017/0226306 A1
(43) Pub. Date: Aug. 10, 2017

(54) Method of Making a Polymer Foam

(71) Applicant: General Electric Company, Schenectady, NY (US)

(72) Inventors: Norberto Silvi, Clifton Park, NY (US); Donald Joseph Buckley, JR., Schenectady, NY (US); David Andrew Simon, Johnstown, NY (US); Davide Louis Simone, Saratoga Springs, NY (US); Joseph Anthony Pavlisko, Pittsford, NY (US)

(21) Appl. No.: 15/018,958

(22) Filed: Feb. 9, 2016

(51) Int. Cl. C08J 9/12

(52) U.S. Cl. CPC C08J 9/122; C08J 2383/04; C08J 2325/12; C08J 2333/12; C08J 2205/044; C08J 2203/06; C08J 2203/08

(57) ABSTRACT

In general, the present invention is directed to a continuous method of making a polymer foam by using a polymer having a first monomeric component and a second monomeric component. The method employs a tandem type extruder having a first extruder and a second extruder. The method disclosed herein can provide a foam having a desired cell size, cell density, porosity, foam density, and/or thermal conductivity, etc. In turn, the polymer foams produced according to the present method can have numerous applications, such as thermal insulation applications for appliances including ovens, freezers, refrigerators, etc.

### FIELD OF THE INVENTION

The present disclosure relates generally to polymer foams and a method of making polymer foams.

### BACKGROUND OF THE INVENTION

Polymer foams have been frequently employed for various applications. For instance, polymer foams have been employed for absorbing certain liquids, absorbing energy, providing insulation, etc. With regards to insulation, the polymer foams have been commonly employed for various thermal insulation applications, such as providing insulation for ovens, freezers, refrigerators, and the like.

These foams play an important role in reducing energies for cooling and heating thereby assisting in energy conservation. For instance, these foams can provide thermal insulation by containing a low thermal conductivity gas in a very small volume inside the polymer foam. However, when the foam has a relatively high thermal conductivity, insulating efficiency decreases thereby increasing the costs of operation. In addition, the thermal conductivity can also be affected by various characteristics of the foam, such as cell size, cell density, porosity, foam density, etc.

There are various methods for producing these polymer foams. However, many of these methods and the resulting foams are undesirable. For instance, foams produced according to these methods may have an undesirable thermal conductivity thereby limiting the effectiveness of the foam.

As a result, there is a continued need for improving the process of forming the polymer foams and thereby improving the characteristics of these foams.

### BRIEF DESCRIPTION OF THE INVENTION

In general, the present disclosure is directed to a continuous method for making a polymer foam. The method comprises a step of extruding a polymer in an extruder system and contacting the polymer with a blowing agent after melting the polymer. The extruder system comprises a tandem-type extruder comprising a first extruder and a second extruder. The polymer comprises a first monomeric component characterized by a glass transition temperature of 80° C. or greater and a second monomeric component characterized by a glass transition temperature of −45° C. or less. The blowing agent is provided in an amount of less than 15 wt. % based on the weight of the polymer.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is an SEM image of a polymer resin employed according to one embodiment of the present disclosure;

FIG. 2 illustrates a tandem-type extruder for making the polymer foams in accordance with one embodiment of the present disclosure;

FIG. 3 is an SEM image of a polymer foam of Comparative Example

FIG. 4 is an SEM image of a polymer foam of Example 1;

FIG. 5 is an SEM image of a polymer foam of Example 2;

FIG. 6 is an SEM image of a polymer foam of Example 3;

FIG. 7 is an SEM image of a polymer foam of Example 4;

FIG. 8 is an SEM image of a polymer foam of Example 5;

FIG. 9 is an SEM image of a polymer foam of Example 6;

FIG. 10 is an SEM image of a polymer foam of Example 7;

FIG. 11 is an SEM image of a polymer foam of Example 8;

FIG. 12 is an SEM image of a polymer foam of Example 9;

FIG. 13 is an SEM image of a polymer foam of Example 10;

FIG. 14 is an SEM image of a polymer foam of Example 11; and

FIG. 15 is an SEM image of a polymer foam of Example 12.

Repeat use of reference characters in the present specification and drawings is intended to represent the same or analogous features or elements of the present invention.

### DETAILED DESCRIPTION OF THE INVENTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

In general, the present invention is directed to a continuous method of making a polymer foam by using a polymer having a first monomeric component and a second monomeric component. In addition, the method also requires a blowing agent for producing the foam. In one embodiment, the first monomeric component may be a thermoplastic component and the second monomeric component may be an elastomeric component. In general, without intending to be limited by theory, the thermoplastic component may have an affinity for the blowing agent while the elastomeric component may enhance the ability of the polymer to absorb the blowing agent. The method disclosed herein can provide a foam having a desired cell size, cell density, porosity, foam density, and/or thermal conductivity, etc. In turn, the polymer foams produced according to the claimed method can have numerous applications, such as thermal insulation applications for appliances including ovens, freezers, refrigerators, etc.

Polymer

In general, any polymer known in the art for producing polymer foams may be employed according to the present disclosure. For instance, the polymer may comprise a thermoplastic polymer, an amorphous polymer, an elastomeric polymer, a semi-crystalline polymer, a thermoset polymer, or any combination thereof. The polymer may be a homopolymer or a copolymer. In addition, more than one polymer may be employed in making the polymer foams.

In one embodiment, the polymer may be a copolymer having a first monomeric component and a second monomeric component. In general, the second monomeric component is different from the first monomeric component. In one embodiment, the first monomeric component may be a thermoplastic component while the second monomeric component may be an elastomeric component. For instance, the copolymer may have structural units derived from a thermoplastic monomer and an elastomeric monomer. The thermoplastic component of the copolymer may include any monomeric component of a thermoplastic polymer known in the art while the elastomeric component of the copolymer may include any monomeric component of an elastomeric polymer known in the art.

Without intending to be limited by theory, it is believed that the thermoplastic component may have a relatively high affinity for a blowing agent, such as carbon dioxide, so that the polar functional groups may promote homogeneous nucleation. Also without intending to be limited by theory, it is believed that the elastomeric component may enhance the ability of the polymers to absorb a blowing agent, such as carbon dioxide, thereby allowing for maximum cell formation. Also without intending to be limited by theory, it is believed that the elastomeric component may act as a nucleating agent to promote heterogeneous nucleation during the decompression step of the process.

In one embodiment, the first monomeric component, such as a thermoplastic component, may be characterized as having a relatively high glass transition temperature and the second monomeric component, such as an elastomeric component, may be characterized as having a relatively low glass transition temperature. In general, the glass transition temperature can be measured using differential scanning calorimetry according to ASTM E1356 with a heating rate of 10° C./min. As used herein, when referring to a monomeric component characterized as having a certain glass transition temperature, it should be understood that such glass transition temperature refers to that of a polymer synthesized from such monomer.

In one embodiment, the first monomeric component, such as a thermoplastic component, may be characterized by a glass transition temperature of 300° C. or less, such as 250° C. or less, such as 200° C. or less, such as 150° C. or less and greater than 0° C., such as 50° C. or greater, such as 80° C. or greater, such as 90° C. or greater. In one embodiment, the first monomeric component may be characterized by a glass transition temperature of from 0° C. to 250° C., such as from 50° C. to 250° C., such as from 80° C. to 250° C., such as from 80° C. to 200° C., such as from 90° C. to 150° C.

In one embodiment, the second monomeric component, such as an elastomeric component, may be characterized by a glass transition temperature of −25° C. or less, such as −30° C. or less, such as −45° C. or less, such as −65° C. or less, such as −80° C. or less, such as −100° C. or less, such as −150° C. or less. The second monomeric component may be characterized by a glass transition temperature of −200° C. or greater, such as −150° C. or greater, such as −125° C. or greater, such as −100° C. or greater, such as −75° C. or greater, such as −50° C. or greater. In one embodiment, the second monomeric component may be characterized by a glass transition temperature of from −45° C. to −150° C., such as from −65° C. to −140° C., such as from −80° C. to −110° C.

In one embodiment, the first monomeric component may be characterized by a glass transition temperature and the second monomeric component may be characterized by a glass transition temperature having a difference of at least about 125° C., such as at least about 175° C., such as at least about 200° C., such as at least about 300° C. and generally about 500° C. or less, such as about 400° C. or less, such as about 350° C. or less, such as about 300° C. or less, such as about 250° C. or less, such as about 200° C. or less.

The copolymer can be derived from any components generally known in the art. For instance, these components may include, but are not limited to, styrene-acrylonitriles, butadienes, acrylates (e.g., methyl methacrylates, butyl acrylates), carbonates, siloxanes (e.g., dimethylsiloxanes), etherim ides, and the like. In general, these components may be characterized by a glass transition temperature as follows: styrene-acrylonitrile (120 ° C.), butadiene (−90° C.), methyl methacrylate (105° C.), butyl acrylate (−49° C.), carbonate (147° C.), siloxane (−125° C.), and etherimide (217° C.).

In particular, the following combinations may be employed according to the present invention: a styrene-acrylonitrile-butadiene copolymer, a poly(methyl methacrylate)/poly(butyl acrylate) copolymer, a polycarbonate/polysiloxane copolymer, and a polyetherimide/polysiloxane copolymer. Some commercial examples include Ineos ABS, Sabic PC EXL-1434T, Sabic Siltem STM1700, and Arkema Nanostrength M53.

In one particular embodiment, the polymer comprises a styrene-acrylonitrile-butadiene copolymer. For instance, the styrene-acrylonitrile may comprise the first monomeric component, such as a thermoplastic component, of the copolymer while the butadiene may comprise the second monomeric component, such as an elastomeric component, of the copolymer.

While only the aforementioned components and combinations are disclosed, any thermoplastic/elastomeric combination that satisfies the elements and limitations disclosed herein may be employed according to the present invention.

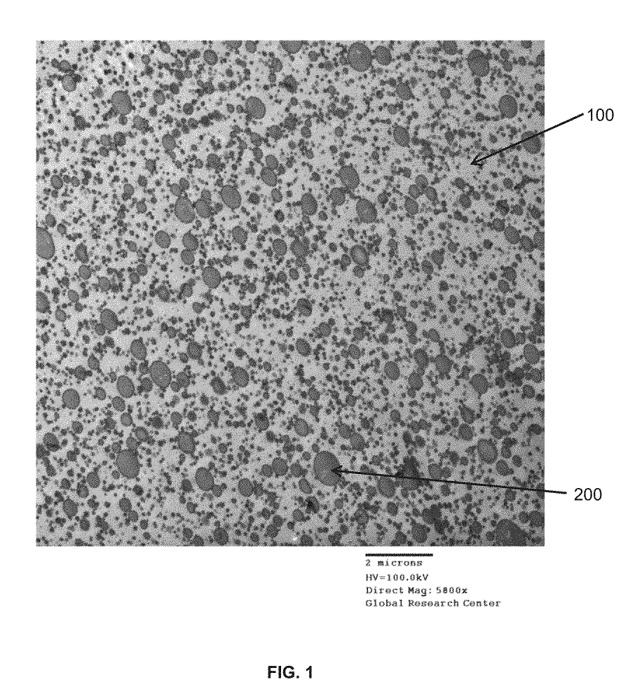

In one embodiment, the polymer may have a major phase and a minor phase. For instance, the first monomeric component, such as a thermoplastic component, may constitute the major phase while the second monomeric component, such as an elastomeric component, may constitute the minor phase. For instance, the minor phase may be dispersed within the major phase. FIG. 1 provides a scanning electron micrograph of a styrene-acrylonitrile-butadiene copolymer. According to FIG. 1, 100 represents the styrene-acrylonitrile component of the copolymer while 200 represents the butadiene component of the copolymer. In this micrograph, the minor phase (i.e., elastomeric component) is dispersed within the major phase (i.e., thermoplastic component).

In one embodiment, the minor phase may be in the form of discrete domains within the major phase. For instance, in one embodiment, the discrete domains may have an average diameter of about 100 μm or less, such as about 50 μm or less, such as about 10 μm or less, such as about 5 μm or less, such as about 1 μm or less. In one embodiment, the discrete domains may have an average diameter of about 1 nm or more, such as about 5 or more, such as about 10 nm or more, such as about 50 nm or more.

As indicated above, the polymer may be a single polymer or a combination of polymers. In this regard, when employing only one polymer, the weight percent of such polymer is 100% based on the total weight of the polymer. When employing more than one polymer, the polymer content is such that at least one polymer is present in an amount of greater than about 50 wt. %, such as greater than about 75 wt. %, such as greater than about 80 wt. %, such as greater than about 90 wt. %, such as greater than about 95 wt. % and generally less than about 100 wt. %, based on the total weight of the polymers.

Blowing Agents

In general, any blowing agent known in the art for producing polymer foams may be employed according to the present disclosure. The blowing agents provided herein can be employed alone or in combination. In addition, the blowing agent may be used in various states (e.g., gaseous, solid, liquid, or supercritical).

The blowing agent may include, but is not limited to, inorganic blowing agents, organic blowing agents, and chemical blowing agents. Examples of inorganic blowing agents include, but are not limited to, carbon dioxide, nitrogen, argon, water, air, helium, etc. Examples of organic blowing agents include, but are not limited to, aliphatic hydrocarbons having 1-9 carbon atoms (e.g., methane, ethane, propane, etc.) and aliphatic alcohols having 1-3 carbon atoms (e.g., methanol, ethanol, etc.). Examples of chemical blowing agents include, but are not limited to, azodicarboxamide, dinitroso-pentamethylene tetramine, azodiisobutyronitrile, benzenesulfonhydrazide, p-toluene sulfonyl semicarbazide, oxybis(benzenesulfonyl hydrazide), barium azodicarboxylate, N,N′-dimethyl-N,N′-dinitrosoterephthalamide, etc.

In one particular embodiment, the blowing agent comprises carbon dioxide. The carbon dioxide may be solid carbon dioxide, liquid carbon dioxide, gaseous carbon dioxide, or supercritical carbon dioxide. In one particular embodiment, the blowing agent comprises supercritical carbon dioxide.

The blowing agent may be employed in an amount of less than 15 wt. %, such as 13 wt. % or less, such as 12 wt. % or less, such as 11 wt. % or less, such as 10 wt. % or less based on the weight of the polymer. The blowing agent may be employed in an amount of 0.5 wt. % or greater, such as 1 wt. % or greater, such as 2 wt. % or greater, such as 5 wt. % or greater, such as 7 wt. % or greater based on the weight of the polymer. In one particular embodiment, the blowing agent may be employed in an amount of from 5 wt. % to less than 15 wt. %, such as from 7 wt. % to 13 wt. %, such as from 9 wt. % to 11 wt. %, based on the weight of the polymer. The aforementioned percentages may also be used to describe the percentage of blowing agent (e.g., CO₂) based on the grams of blowing agent in relation to the grams of extrudate.

In one embodiment, the amount of blowing agent does not exceed the solubility limit of the blowing agent in the polymer based on the temperature and pressure at the injection point of the blowing agent. The solubility limit can be determined using a magnetic suspension balance according to the gravimetric method described in Sato et al., Journal of Supercritical Fluids, 19 (2001) 187-198.

Other Additives

In addition, various additives for producing polymer foams may also be employed according to the present disclosure. For instance, the additives may include antioxidants, anti-drop agents, anti-ozonants, impact modifiers, UV absorbers, flow promoters, pigments, dyes, thermal stabilizers, fire-retardant agents, processing aids, extrusion aids, anti-corrosion additives, mold release agents, fillers, anti-static agents, lubricants, nucleating agents, surfactants, and the like.

In general, nucleating agents can be used to promote bubble formation and/or develop cells of a particular pore size. These nucleating agents include, but are not limited to, talc, silica, kaolin, mica, zinc oxide, titanium oxide, calcium silicate, clay, calcium carbonate, zeolite, a stearate, paraffin, an olefin wax, etc. When employed, the nucleating agent can be present in an amount of about 10 wt. % or less, such as about 5 wt. % or less, such as about 2 wt. % or less and about 0.1 wt. % or more, such as about 0.5 wt. % or more, such as about 1 wt. % or more, based on the weight of the polymer.

In general, surfactants can be employed to reduce the interfacial tension between the carbon dioxide and the polymer and thus reduce the characteristic size of the blowing agent cells present in the foam. The surfactant can be any type known in the art for producing polymer foams, such as non-ionic surfactants. The surfactants include, but are not limited to, polypropylene glycol/polyethylene glycols (PPG/PEG) surfactants, such as those available under the tradename Pluronic®. When employed, the surfactant can be present in an amount of about 10 wt. % or less, such as about 5 wt. % or less, such as about 2 wt. % or less and about 0.1 wt. % or more, such as about 0.5 wt. % or more, such as about 1 wt. % or more, based on the weight of the polymer.

Method and Extruder Design

In general, the method disclosed herein can provide polymer foams having a desired cell size, cell density, porosity, foam density, and/or thermal conductivity, etc. In turn, the polymer foams produced according to the claimed method can have numerous applications, such as thermal insulation applications.

In general, the polymer foams of the present invention can be made according to a continuous process. In this regard, the polymer foams can be made continuously without interruption so long as ingredients are provided. Without intending to be limited, the continuous process may allow for high-output in comparison to a batch process.

In one embodiment, the polymer foams can be made using an extruder. In one particular embodiment, the extruder may be a tandem type extruder including a first extruder and a second extruder. For instance, the extrudate from the first extruder may be directly injected into the second extruder. The first extruder and the second extruder may be in series. The extruders may be a single screw extruder or a twin-screw extruder. In one particular embodiment, the polymer foams are made according to a continuous extrusion process utilizing a tandem type extruder.

In general, the polymer and additives, if employed, can be introduced to the throat region of the first extruder. While the additives can be fed with the polymer, it should be understood that the additives can be pre-mixed with the polymer prior to being fed to the extruder. In addition, it should also be understood that the additives can be added downstream from the addition of the polymer. After supplying the polymer to the extruder, the polymer is heated and melted in the extruder.

The blowing agent can also be introduced into the first extruder to contact the polymer. In general, the blowing agent is supplied after some or all of the polymer has melted. Therefore, the blowing agent is introduced downstream from the addition of the polymer. The blowing agent can be injected via one injection point or can be injected at multiple locations in the first extruder. By allowing the blowing agent to be introduced after melting of the polymer, the blowing agent can be dissolved into the polymer.

In one embodiment, the blowing agent, such as carbon dioxide, is injected at a pressure above the critical pressure at the temperature of the melt in the injection zone of the blowing agent. In this regard, the blowing agent, such as carbon dioxide, may be injected in a supercritical state.

In one embodiment, the blowing agent, such as carbon dioxide, is introduced to the first extruder when the temperature of the extruder and polymer is greater than the glass transition temperature or softening temperature of the polymer. In this regard, the polymer may be more fluid thereby facilitating mixing of the carbon dioxide with the polymer.

As the polymer and blowing agent, such as carbon dioxide, mix, they may form a single, homogeneous phase. In the second extruder, the single phase may be exposed to an even higher pressure than the pressure of the first extruder, such as at the injection point of the blowing agent in the first extruder. In the second extruder, the mixture may be cooled down at a relatively high pressure.

Upon exiting the second extruder, the single phase mixture may be decompressed to atmospheric conditions to separate the carbon dioxide from the polymer in order to form the polymer foam. In addition, upon exiting, the polymer foam can be quenched during expansion. This may allow for control of the pore size. The quenching may be conducted in a bath. For instance, the quench temperature can be less than or equal to the glass transition temperature of the first monomeric component, such as the thermoplastic component, of the copolymer.

In addition, the foaming of the polymer may occur as a result of phase separation kinetics between the polymer and the blowing agent. For instance, the mechanism of phase separation may occur by nucleation and growth, spinodal decomposition, etc.

In general, a blowing agent diffuses into the polymer at a high pressure, such as a very high saturation pressure, to form a single phase of the gas and polymer. This single phase may be referred to as a homogeneous phase. By quenching the pressure and/or temperature, thermodynamic instability can be induced in this phase to separate the gas molecules from the polymer resulting in nucleation and growth of the gas bubbles. In general, nucleation refers to the process by which a homogeneous solution of polymeric material and dissolved molecules of a gas under ambient conditions undergoes formation of clusters of the molecules that define nucleation sites from which cells will grow. In this regard, this process is a change from a homogeneous solution to a multi-phase mixture wherein sites of aggregation of molecules of the blowing agent are formed.

In general, the extent of nucleation can depend on the magnitude of a pressure drop, the number of gas molecules in the polymer, the temperature, etc. The nuclei then grow due to the concentration gradient of the gas. This enables the production of cells which are thereafter stabilized and the foam is formed into a desired shape. In general, the polymer foams can be extruded into any desired shape having a desired size and thickness.

The blowing agent can be introduced to the first extruder at a pressure of from 1,000 to 5,000 psi, such as from 2,000 to 4,000 psi at a temperature of 0° C. In general, the blowing agent, such as carbon dioxide, is introduced at a relatively low pressure. For instance, the blowing agent may be introduced at a relatively low pressure while in a supercritical state.

When employing a tandem type extruder, the first extruder may operate at a pressure of from 1,000 to 5,000 psi, such as from 2,000 to 4,000 psi. The second extruder may operate at a pressure of from 5,000 to 8,500 psi, such as from 6,000 to 7,500 psi. In general, the operating pressure of the second extruder is higher than the operating pressure of the first extruder. In one embodiment, the temperature in the second extruder is reduced along the extruder thereby increasing the pressure. In this regard, the temperature at the throat region of the second extruder where the extrudate of the first extruder is introduced can be higher than the temperature downstream.

When employing a tandem type extruder, the first extruder may have a maximum pressure of from 1,000 to 5,000 psi, such as from 2,000 to 4,000 psi. The second extruder may have a maximum pressure of from 5,000 to 8,500 psi, such as from 6,000 to 7,500 psi.

In general, when employing a tandem type extruder, the pressure can be increased in the second extruder, which may be a cooling extruder, by at least a factor of about 1.5, such as at least a factor of about 2 and generally less than a factor of about 5, such as less than a factor of about 4, such as less than a factor of about 3. Such increase in pressure can be achieved by decreasing the temperature in the second extruder. In this regard, the pressure in the second extruder can be greater than the pressure at the injection point of the blowing agent. In one embodiment, the injection pressure is the lowest pressure of the process.

In general, the extrusion temperature is generally about 400° C. or less, such as about 300° C. or less, such as about 250° C. or less. When employing a tandem type extruder, the first extruder may operate at a temperature of about 400° C. or less, such as about 350° C. or less, such as about 300° C. or less and about 100° C. or more, such as about 150° C. or more, such as about 200° C. or more. In this regard, the polymer is heated at a temperature sufficient to melt the polymer. Therefore, the melt mixing temperature is at or above the glass transition temperature or melting point of the polymer.

When employing a second extruder, the first extruder may operate at a temperature of about 350° C. or less, such as about 300° C. or less, such as about 250° C. or less and about 100° C. or more, such as about 150° C. or more, such as about 200° C. or more. In general, the second extruder may be operated at a temperature at or slightly above the polymer glass transition temperature. In general, the extrusion can be conducted at a relatively low temperature.

Without intending to be limited by theory, it is believed that the solubility of the blowing agent, such as carbon dioxide, can be increased in the second extruder by reducing the temperature in the second extruder and increasing the pressure. This may help disperse the blowing agent with the polymer. In addition, it is also believed that the blowing agent, such as carbon dioxide, can plasticize the polymer and reduce the glass transition temperature of the polymer which also may help maintain the viscosity for processing via extrusion. In addition, this may allow for processing of the polymer at temperatures below the original glass transition temperature of the polymer.

The total residence time of the polymer in the extrusion system, such as a tandem type extrusion system, is generally about 2 hours or less, such as about 1.5 hours or less, such as about 1 hour or less and about 0.1 hours or more, such as about 0.25 hours or more, such as about 0.33 hours or more, such as about 0.5 hours or more. In one embodiment, the total residence time is from about 0.33 hour to about 1 hour.

When employing a tandem type extruder, the residence time in the first extruder is about 30 minutes or less, such as about 20 minutes or less, such as about 15 minutes or less, such as about 12 minutes or less and about 1 minute or more, such as about 2 minutes or more, such as about 3 minutes or more. In one embodiment, the residence time in the first extruder is from about 5 minutes to about 10 minutes.

When employing a tandem type extruder, the residence time in the second extruder is about 1.5 hours or less, such as about 1.25 hours or less, such as about 1 hour or less, such as about 50 minutes or less and about 5 minutes or more, such as about 10 minutes or more, such as about 13 minutes or more. In one embodiment, the residence time in the second extruder is from about 15 minutes to about 45 minutes.

When employing a tandem type extruder, the first extruder may have an L/D of from about 5 to about 100, such as from about 10 to about 75, such as from about 20 to about 50. When employing a tandem type extruder, the second extruder may have an L/D of from about 5 to about 100, such as from about 10 to about 75, such as from about 20 to about 50.

When employing a tandem type extruder, the first extruder may have a diameter of from about 0.25 inches to about 10 inches, such as from about 0.25 inches to about 5 inches, such as from about 0.5 inches to about 2 inches, such as from about 0.5 inches to about 1 inch, such as about 0.75 inches. When employing a tandem type extruder, the second extruder may have a diameter of from about 0.25 inches to about 10 inches, such as from about 0.5 inches to about 5 inches, such as from about 0.75 inches to about 2.5 inches, such as from about 1 inch to about 2 inches, such as about 1.5 inches.

When employing a tandem type extruder, the first extruder may have a screw speed of from about 1 rpm to about 200 rpm, such as from about 10 rpm to about 100 rpm. When employing a tandem type extruder, the second extruder may have a screw speed of from about 1 rpm to about 100 rpm, such as from about 1 rpm to about 50 rpm. When employing a tandem type extruder, the ratio of the screw speed of the first extruder to the screw speed of the second extruder is from about 1 to about 200, such as from about 3 to about 100, such as from about 4 to about 10. In general, the screw speed of the first (or primary) extruder is greater than the screw speed of the second (or secondary) extruder. In general, this may be the result of the diameter of the second (or secondary) extruder being generally larger than the diameter of the first (or primary) extruder.

Upon exiting the second extruder, the blowing agent undergoes nucleation and growth in the block copolymer and expands the polymer to produce the foam. In general, while the relative foam density is defined as the ratio of the foamed to unfoamed polymer density, the expansion ratio is defined as the inverse of such. Such foam densities can be determined using any method known in the art. For instance, the foam density can be measured using a water displacement method in accordance with ASTM D792. In general, the expansion ratio may be about 1 or greater, such as about 2 or greater, such as about 5 or greater, such as about 10 or greater and about 40 or less, such as about 30 or less, such as about 20 or less, such as about 10 or less. The expansion ratio may be about 5 to about 30, such as from about 5 to about 20, such as from about 5 to about 10.

The polymer foam may contain open cells, closed cells, or a combination thereof. For instance, an open cell structure is defined as a void cavity that is open at one or more sides. Open cell structures may connect to other open cell structures. A closed cell structure is defined as a void cavity with no opening. In one embodiment, the polymer foam contains closed cells. In general, by containing closed cells, the thermal conductivity of the polymer foam can be reduced.

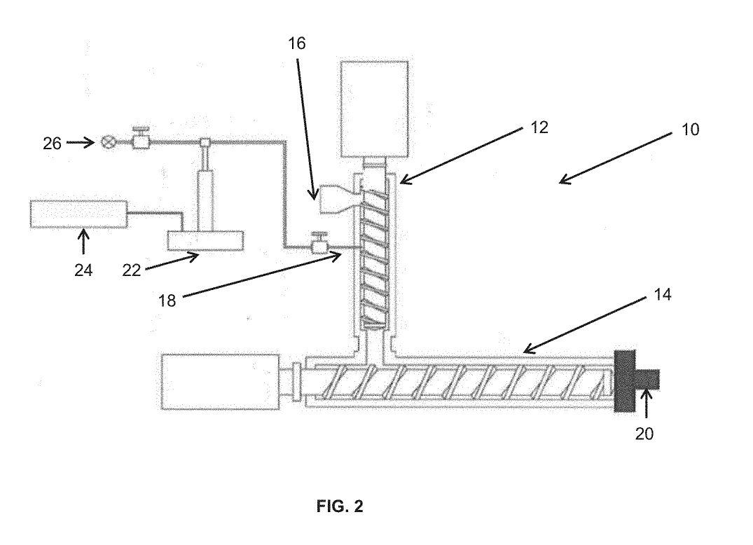

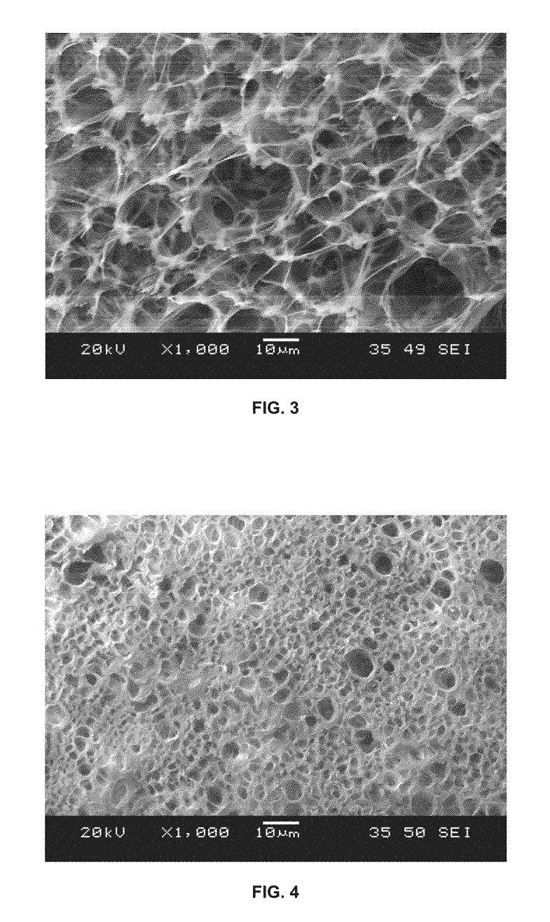

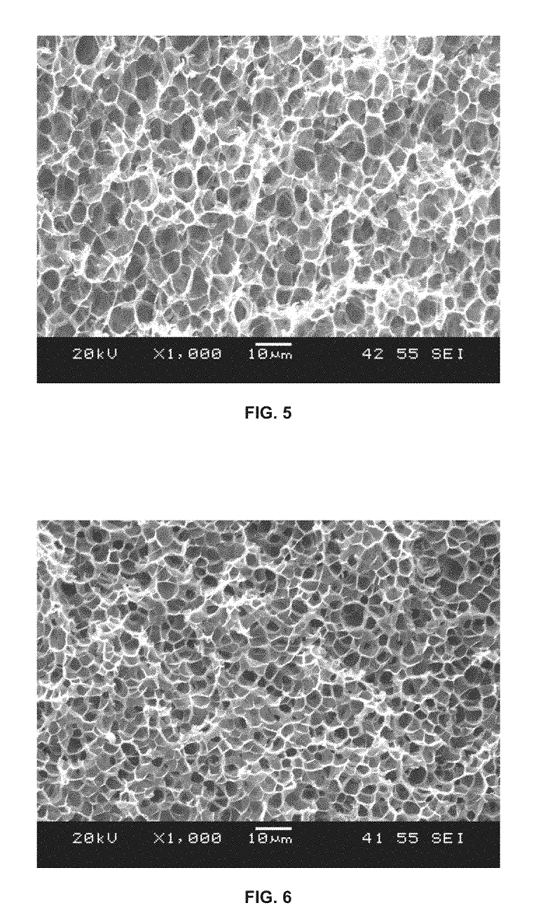

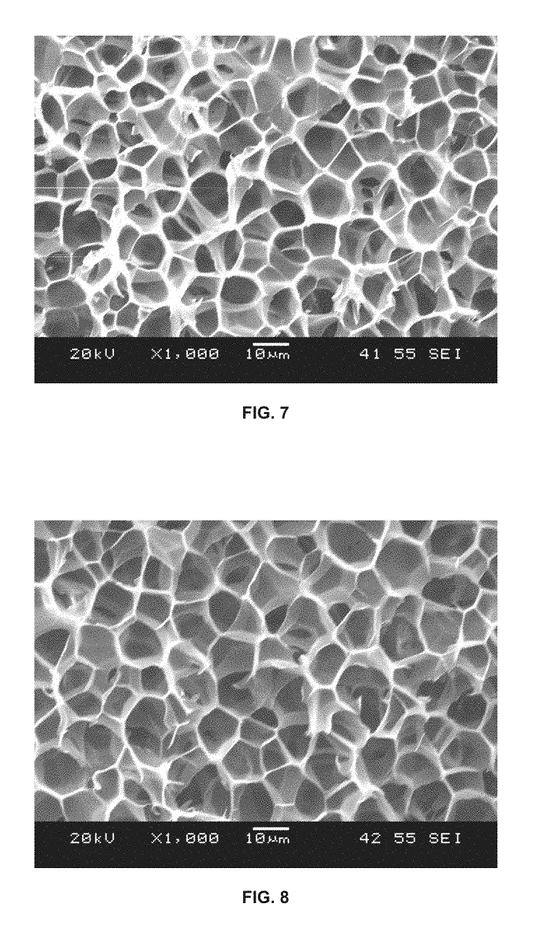

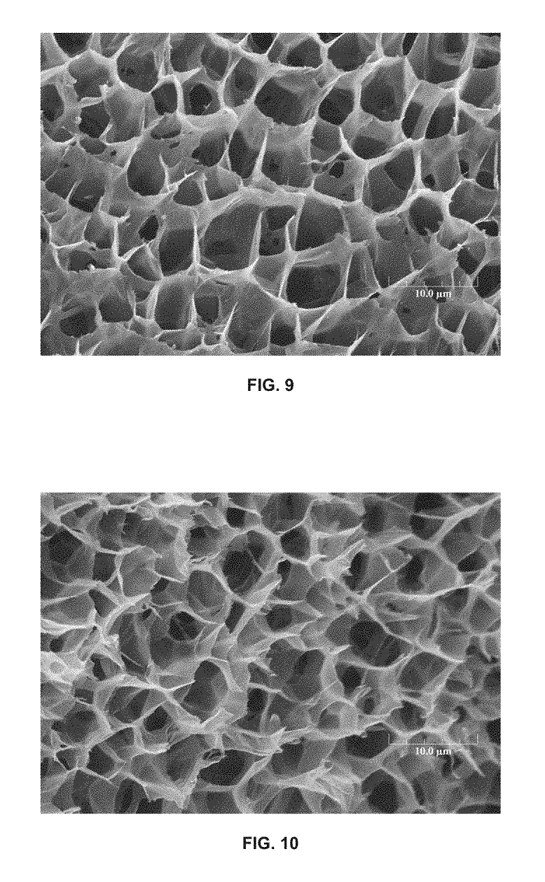

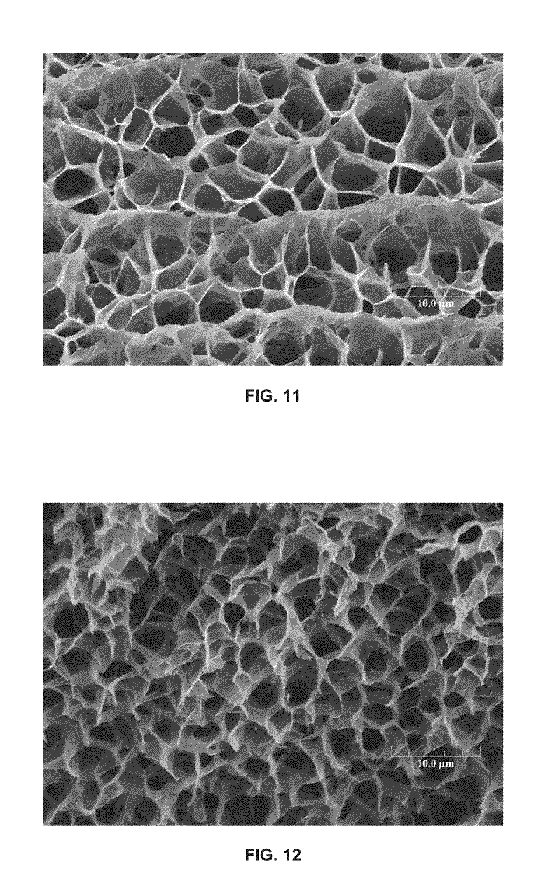

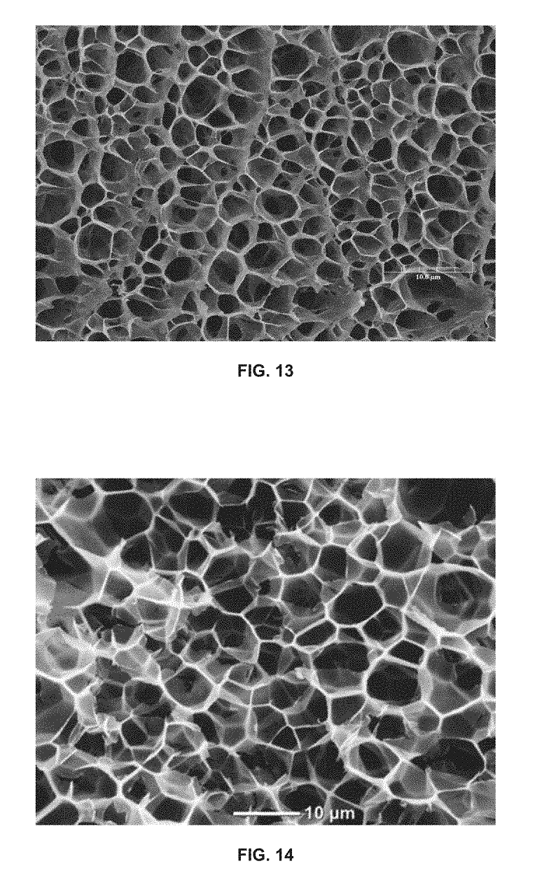

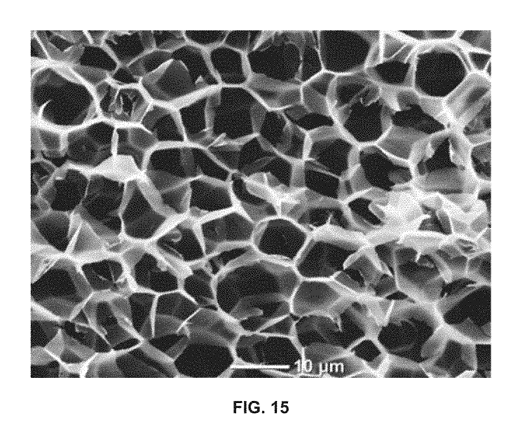

One embodiment of the method for producing the polymer foams using an extrusion process will now be described in detail with respect FIG. 2. The tandem type extruder 10 includes a first extruder 12 and a second extruder 14. The extruders include a barrel with a screw positioned therein. The polymer, generally in the form of pellets or flakes, is introduced into the first extruder 12 via hopper 16. When other additives are provided, they can be added with the polymer or downstream from the polymer.

As the polymer traverses through the first extruder, it is heated and melted. In the event a thermoplastic material is used, the material may become plasticized. The blowing agent, such as carbon dioxide, is subsequently introduced to the first extruder 12 through inlet 18 from supply 26 using a positive displacement pump 22 that is regulated by a pump controller 24. The first extruder 12 can be employed to assist in contacting the blowing agent with the polymer and mixing the polymer and the blowing agent.

The blowing agent and the molten polymer are mixed in the first extruder 12 downstream from inlet 18 wherein the blowing agent diffuses into the polymer. In general, the blowing agent and the polymer are a single phase at this stage. The polymer and blowing agent then traverse through first extruder 12 and into second extruder 14. The polymer and blowing agent then traverse through the second extruder 14 and through die 20. In the second extruder 14, the polymer and blowing agent experience a temperature drop which in turn increases the pressure. Upon exiting through die 20, the material may experience a pressure drop and a sudden decrease in the solubility of the blowing agent. Accordingly, a large number of bubbles may nucleate almost instantaneously in the matrix of the material and as a result a polymer foam is formed. The foamed material may be further processed into an article of manufacture as desired by the end user.

In general, the polymer foams produced according to the method disclosed herein can have certain desired properties such as a certain cell size, cell density, porosity, foam density, and/or thermal conductivity, etc. The foams made according to the present disclosure may have a relatively low density, high porosity, and low thermal conductivity.

In general, the polymer foam may have a porosity of 75% or more, such as 80% or more, such as 85% or more, such as 87% or more, such as 90% or more, such as 92% or more, such as 94% or more. In general, the porosity is less than 100%, such as 99% or less, such as 97% or less. To determine the porosity of a foam, any general method known in the art can be employed. For instance, a cross-section of the foam can be observed with a microscope and the porosity can be determined using an image analyzing apparatus or software. The porosity can also be determined based on the density of the polymer and the density of a polymer foam. The density of the foam can be determined according to ASTM D-1622-03.

In addition, the polymer foam may have cells that have a number average diameter of 10 microns or less, such as 9 microns or less, such as 7 microns or less, such as 5 microns or less. In general, the average cell diameter can be determined using any method known in the art. For instance, the size can be determined by preparing a cross section of a foam by cryo-fracturing, examining the cross section via scanning electron microscopy, measuring the cell size of the cells, and determining the average of all the measured sizes.

In addition, the cell diameter generally refers to an equivalent diameter circle that indicates the diameter of a circle having the same area as the area of the cell. In one embodiment, the polymer foams produced according to the present invention do not have a bimodal cell size distribution.

In general, the polymer foam may have a cell density of about 10⁹ cells/cm³ or more, such as about 10¹⁰ cells/cm³ or more, such as about 10¹¹ cells/cm³ or more, such as about 10¹² cells/cm³ or more, such as about 10¹³ cells/cm³ or more, such as about 10¹⁴ cells/cm³ or more, such as about 10¹⁵ cells/cm³ or more. In general, it is desired to increase the cell density and decrease the cell size which in turn can result in an increase in porosity. In general, the foam may have a relatively high cell density. In order to determine the cell density, the cells of the foam were approximated as a cube and the cell density (in number of cells per cm³ of foam) was calculated as the ratio of the foam's porosity divided by the cube of the cell diameter. In general, this is known in the art as the cubic approximation technique based on ASTM D3576-15.

Applications

Polymer foams made according to the present invention can have numerous applications. For instance, the foam can be used in the automotive industry, biomedical industry, construction industry, etc.

In one particular embodiment, the polymer foams can be used to provide thermal insulation. For instance, the polymer foams can be employed to provide thermal insulation for various appliances and systems. These appliances and systems include, but are not limited to, ovens, ranges, freezers, refrigerators, refrigeration systems, heaters/heating systems, and the like.

The present disclosure may be better understood with reference to the following examples.

### EXAMPLE

The examples of the invention are given below by way of illustration and not by way of limitation. The following experiments were conducted in order to show some of the benefits and advantages of the present invention.

In the examples, a tandem type extruder equipped with a supply line of supercritical carbon dioxide was employed. The supercritical carbon dioxide and the copolymer were mixed in a first extruder. The injection pressure, screw speed and melt temperature of the first extruder are provided in Table 1 below. The mixture was supplied to a second extruder and cooled to a temperature and pressure as provided in Table 1 below.

As indicated below, all polymers were processed using a tandem type extrusion system. For extrusion system 1, the primary single screw extruder had a diameter of 0.75″ and an L/D of 30 while the secondary single screw extruder had a diameter of 1.5″ and an L/D of 18. For extrusion system 2, the primary single screw extruder had a diameter of 0.75″ and an L/D of 34 while the secondary single screw extruder had a diameter of 1.5″ and an L/D of 30.

The results of the polymer foams are shown in Table 1 below.

| | | | Primary Extruder | | |
|---|---|---|---|---|---|
| | | | Injection | Screw | |
| | | Extrusion | Pressure | Speed | Temperature |
| Example | Copolymer | System | (psi) | (rpm) | (° C.) |
| Comp. | PC 101 | 1 | — | — | — |
| Ex. 1 | | | | | |
| Ex. 1 | PC-PDMS | 1 | — | — | — |
| Ex. 2 | ABS | 1 | — | 21 | — |
| Ex. 3 | ABS | 1 | — | 25 | — |
| Ex. 4 | ABS | 1 | — | 21 | — |
| Ex. 5 | ABS | 1 | — | 35 | — |
| Ex. 6 | ABS | 2 | 2961 | 15 | 216 |
| Ex. 7 | ABS | 2 | 2712 | 20 | 214 |
| Ex. 8 | ABS | 2 | 2535 | 25 | 213 |
| Ex. 9 | ABS | 2 | 2485 | 30 | 213 |
| Ex. 10 | ABS | 2 | 2203 | 24 | 212 |
| Ex. 11 | PMMA-PBA | 2 | 2573 | 15 | 217 |
| Ex. 12 | PMMA-PBA | 2 | 3502 | 15 | 220 |

| | Secondary Extruder | | | | | |
|---|---|---|---|---|---|---|
| | Die Tem- | Die | Screw | Extrudate | CO₂ | % CO₂ |
| Exam- | perature | Pressure | Speed | Rate | Rate | (g CO₂/g |
| ple | (° C.) | (psi) | (rpm) | (g/min) | (mL/hr) | Extrudate) |
| Comp. | 167 | 2750 | — | 12 | 43.2 | 6 |
| Ex. 1 | | | | | | |
| Ex. 1 | 155 | 2350 | — | 12 | 43.2 | 6 |
| Ex. 2 | 135 | 2700 | 4.5 | 10 | 54 | 9 |
| Ex. 3 | 115 | 2977 | 3.3 | 10 | 54 | 9 |
| Ex. 4 | 120 | 2550 | 2.7 | 10 | 54 | 9 |
| Ex. 5 | 115 | 2862 | 3.5 | 10 | 54 | 9 |
| Ex. 6 | 115 | 4690 | 3 | — | 60 | — |
| Ex. 7 | 116 | 4318 | 4 | — | 60 | — |
| Ex. 8 | 116 | 4093 | 5 | 16.2 | 60 | 6.2 |
| Ex. 9 | 115 | 3983 | 6 | 16.5 | 60 | 6.1 |
| Ex. 10 | 110 | 2798 | 5 | 13.4 | 60 | 7.5 |
| Ex. 11 | 115 | 5543 | 3 | 10.8 | 70 | 10.8 |
| Ex. 12 | 115 | 7028 | 3 | 13.2 | 70 | 8.8 |

| | Foam | | | Cell | Cell | |
|---|---|---|---|---|---|---|
| | Density | Expansion | Porosity | Diameter | Density | |
| Example | (g/cm³) | Ratio | (%) | (μm) | (cells/cm³) | FIG. |
| Comp. | 0.0933 | 12.86 | 92 | 12 | 5.34E+08 | 3 |
| Ex. 1 | | | | | | |
| Ex. 1 | 0.2644 | 4.5 | 78 | 4 | 1.22E+10 | 4 |
| Ex. 2 | 0.1155 | 8.92 | 89 | 6.5 | 3.23E+09 | 5 |
| Ex. 3 | 0.1055 | 9.76 | 90 | 6 | 4.16E+09 | 6 |
| Ex. 4 | 0.1192 | 8.64 | 88 | 9 | 1.21E+09 | 7 |
| Ex. 5 | 0.1198 | 8.6 | 88 | 10 | 8.84E+08 | 8 |
| Ex. 6 | 0.0650 | 16.8 | 94 | 5 | 7.52E+09 | 9 |
| Ex. 7 | 0.0650 | 15.8 | 94 | 5 | 7.50E+09 | 10 |
| Ex. 8 | 0.0650 | 15.8 | 94 | 5 | 7.50E+09 | 11 |
| Ex. 9 | 0.0700 | 15.0 | 93 | 4 | 1.46E+10 | 12 |
| Ex. 10 | 0.1200 | 8.6 | 88 | 4 | 1.38E+10 | 13 |
| Ex. 11 | — | — | — | 5 | — | 14 |
| Ex. 12 | — | — | — | 7 | — | 15 |

Comparative example 1 shows the properties of a foam prepared from supercritical carbon dioxide and a polycarbonate homopolymer resin. Example 1 shows the properties of a foam prepared from carbon dioxide and a copolymer of polycarbonate and a polydimethylsiloxane polymer. These results showed that the PC-PDMS foam had a lower porosity, a smaller cell size, and a larger cell density compared to the foam made from the polycarbonate homopolymer. Also, the polycarbonate foam showed an open-cell structure whereas the PC-PDMS foam showed a closed-cell structure, which may be preferred for thermal insulation applications.

Examples 2 through 5 show the properties of foams made from supercritical carbon dioxide and different ABS resins. These resins differed in their SAN loading, molecular weight, and in the amount of the elastomeric dispersed phase. These foams showed a high porosity and a small cell diameter and therefore a relatively high cell density.

Examples 6 through 9 show the properties of foams made from supercritical carbon dioxide and the same ABS resin but under different screw speed conditions in both extruders. These foams show high porosities and a characteristic cell dimension of only 5 microns and lower. Example 10 shows the properties of an ABS foam having a porosity of 88%, cell size of only 4 microns, and a cell density larger than 10¹⁰ cells per cm³ of foam.

Examples 11 and 12 relate to foams prepared from supercritical carbon dioxide and a mixture of PMMA and a poly(methyl methacrylate)/poly(butyl acrylate)/poly(methyl methacrylate) terpolymer. The material of Example 11 was pre-compounded from a mixture containing 95 parts by weight of PMMA and 5 parts by weight of a PMMA-PBA-PMMA terpolymer (Arkema's Nanostrength M53). The material of Example 12 was pre-compounded from a mixture containing 90 parts by weight of PMMA and 10 parts by weight of a PMMA-PBA-PMMA terpolymer (Arkema's Nanostrength M53). Both of these foamed materials contained closed cells of 7 microns in size and smaller.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

What is claimed is:

1. A continuous method for making a polymer foam, the method comprising
extruding a polymer in an extruder system comprising a tandem-type extruder comprising a first extruder and a second extruder,
contacting the polymer with a blowing agent after melting the polymer,
wherein the polymer comprises a first monomeric component characterized by a glass transition temperature of 80° C. or greater and a second monomeric component characterized by a glass transition temperature of −45° C. or less, and
wherein the blowing agent is provided in an amount of less than 15 wt. % based on the weight of the polymer.

2. The method according to claim 1, wherein the first monomeric component is characterized by a glass transition temperature of 90° C. or greater.

3. The method according to claim 1, wherein the second monomeric component is characterized by a glass transition temperature of −80° C. or less.

4. The method according to claim 1, wherein the first monomeric component is characterized by a glass transition temperature of from 80° C. to 250° C. and the second monomeric component is characterized by a glass transition temperature of from −45° C. to −150° C.

5. The method according to claim 1, wherein the first monomeric component is characterized by a glass transition temperature and the second monomeric component is characterized by a glass transition temperature, wherein the difference in the glass transition temperature is from about 125° C. to about 350° C.

6. The method according to claim 1, wherein the first monomeric component comprises styrene and acrylonitrile.

7. The method according to claim 1, wherein the second monomeric component comprises butadiene.

8. The method according to claim 1, wherein the first monomeric component comprises a carbonate, a methyl methacrylate, or an etherimide.

9. The method according to claim 1, wherein the second monomeric component comprises a siloxane or a butyl acrylate.

10. The method according to claim 1, wherein the polymer comprises an acrylonitrile/butadiene/styrene copolymer.

11. The method according to claim 1, wherein the polymer comprises a poly(methyl methacrylate)/poly(butyl acrylate) copolymer, a polycarbonate/polysiloxane copolymer, or a polyetherimide/polysiloxane copolymer.

12. The method according to claim 1, wherein the blowing agent comprises carbon dioxide.

13. The method according to claim 12, wherein the carbon dioxide is supercritical carbon dioxide.

14. The method according to claim 1, wherein the blowing agent is provided in an amount of 12 wt. % or less based on the weight of the polymer.

15. The method according to claim 1, wherein the pressure in the second extruder is increased by at least a factor of 2.

16. The method according to claim 1, wherein the blowing agent is injected to the first extruder at an injection point and the pressure in the second extruder is greater than the pressure at the injection point.

17. A polymer foam made according to the method of claim 1, wherein the foam has a porosity of 75% or higher.

18. A polymer foam made according to the method of claim 1, wherein the foam comprises cells having an average cell size of 10 microns or less.

19. A polymer foam made according to the method of claim 1, wherein the foam has a cell density of 10⁹ cells/cm³ or more.
